(19) United States
(12) Patent Application Publication
(10) Pub. No.: US 2015/0207917 A1
(43) Pub. Date: Jul. 23, 2015

(54) MOBILE TERMINAL INTELLIGENT ANTI-THEFT METHOD AND MOBILE TERMINAL

(71) Applicant: Beijing Netqin Technology Co., Ltd., Beijing (CN)

(72) Inventors: Xiao Yang, Beijing (CN); Da Fu, Beijing (CN); Zhaoxin Gai, Beijing (CN); Linlin Gong, Beijing (CN); Guangyan Liu, Beijing (CN); Xia Zou, Beijing (CN)

(21) Appl. No.: 14/421,261

(22) PCT Filed: Mar. 7, 2013
(86) PCT No.: PCT/CN2013/072289

§ 371 Date: Feb. 12, 2015

(30) Foreign Application Priority Data
Dec. 14, 2012 (CN) 201210545230.7

(51) Int. Cl. H04M 1/725; H04W 12/08

(52) U.S. Cl. CPC H04M 1/72538; H04W 12/08; H04M 1/72577

(57) ABSTRACT

The present invention provides a mobile terminal anti-theft method (100) which comprises triggering mobile terminal anti-theft operations according to operations on a mobile terminal (S110). The mobile terminal anti-theft operations at least comprise: collecting location information and environment information of the mobile terminal (S122, S124) and backing up private data of the mobile terminal (S126) and sending the collected location information and environment information and the backup private data to a result designated location (S130). The present disclosure further provides a mobile terminal (200) for achieving the mobile terminal anti-theft method (100).

### TECHNICAL FIELD

The disclosure relates to the field of mobile communication, and particularly to a mobile terminal intelligent anti-theft method and a mobile terminal for achieving the same.

### BACKGROUND

Most existing mobile terminal anti-theft methods are proactively triggered by users of lost mobile terminals (such as cell phones, tablet computers, portable computers, etc.). On the condition that a mobile terminal anti-theft service is activated, when a user cannot find his mobile terminal, by means of a set of predefined anti-theft instructions, he may be able to locate his mobile terminal and retrieve important data (e.g. contacts, call history, SMS messages, MMS messages, photos, videos, SD card data, and account information, etc.), and further delete such data to protect personal privacy and information security.

The disadvantages of such anti-theft methods are that: after the mobile terminal is lost, the user may have to find another device to log into the server for operation; the operations are sometimes complicated, and thus may be difficult enough for users to perform correctly and/or may be easily forgotten; real-time performance is poor due to delay of logging in and operations; and user experience may be terrible due to the need of logging in and operations and possibly impatient temper of users when handling lost articles.

### SUMMARY

The present disclosure provides a mobile terminal intelligent anti-theft method and a mobile terminal for achieving the above mobile terminal intelligent anti-theft method. In the present disclosure, the mobile terminal may automatically determine theft status of the mobile terminal and hence automatically trigger mobile terminal anti-theft operations: collecting clues (location information, environment information, etc.) in time, obtaining and backing up important personal data (private data), and further deleting private data and/or prompting to return information, etc. The user does not need to master complicated anti-theft setting and operations, and may trigger the anti-theft operations as soon as he knows that his mobile terminal is lost, guaranteeing promising real-time performances.

Particularly, according to a first aspect of the disclosure, a mobile terminal intelligent anti-theft method is provided. The method includes: triggering mobile terminal anti-theft operations according to operations on a mobile terminal, wherein the mobile terminal anti-theft operations at least include: collecting location information and environment information of the mobile terminal, backing up private data in the mobile terminal, and sending the collected location information and environment information of the mobile terminal and the backup private data to a result designated location.

According to some embodiments of the disclosure, the mobile terminal anti-theft operations may be triggered when the operations on the mobile terminal fulfill one of the following conditions: the number of failed unlocking attempts of the mobile terminal reaches a predetermined number; the mobile terminal is forcedly turned off when in locked status; the SIM card is replaced when the mobile terminal is in locked status; incorrect password is inputted when requesting restoring factory settings.

According to some embodiments of the disclosure, the mobile terminal anti-theft operations further include: sending an anti-theft operation initiation notification to a notification designated location. According to still some embodiments of the disclosure, the mobile terminal anti-theft operations further include: deleting the private data in the mobile terminal after the backup private data is sent to the result designated location. According to yet some embodiments of the disclosure, the mobile terminal anti-theft operations further include: when SIM card replacement is detected, collecting information of a replacing SIM card; and sending the information of the replacing SIM card to the result designated location. According to yet some embodiments of the disclosure, the mobile terminal anti-theft operations further include: displaying and/or voice broadcasting contact information of the mobile terminal's owner to prompt to return the mobile terminal, the contact information includes at least one of: phone numbers, email addresses, work place addresses, and home addresses. In such embodiments, the mobile terminal anti-theft operations may further include: sending a prompt receipt notification to the notification designated location.

According to a second aspect of the present disclosure, a mobile terminal is provided. The mobile terminal includes: a theft status determination unit configured to trigger mobile terminal anti-theft operations according to operations on the mobile terminal; an information collecting unit configured to collect location information and environment information of the mobile terminal and back up private data in the mobile terminal, based on instructions from the theft status determination unit; and an information sending unit configured to send the location information and the environment information of the mobile terminal which is collected by the information collecting unit and the backup private data to a result designated location.

According to some embodiments of the disclosure, the information sending unit is further configured to send an anti-theft operation initiation notification to a notification designated location.

According to some embodiments of the disclosure, the theft status determination unit may trigger the mobile terminal anti-theft operations when the operations on the mobile terminal fulfill one of the following conditions: the number of failed unlocking attempts of the mobile terminal reaches a predetermined number; the mobile terminal is forcedly turned off when in locked status; the SIM card is replaced when the mobile terminal is in locked status; an incorrect password is inputted when requesting restoring factory settings.

According to some embodiments of the disclosure, the information collecting unit deletes the private data in the mobile terminal after the backup private data is sent to the result designated location by the information sending unit.

According to some embodiments of the disclosure, the information collecting unit is further configured to detect whether the SIM card is replaced, and collect information of a replacing SIM card when SIM card replacement is detected; and the information sending unit is further configured to send the information of the replacing SIM card to the result designated location.

According to some embodiments of the disclosure, the mobile terminal further includes: an information presenting unit configured to display and/or voice broadcast contact information of the mobile terminal's owner to prompt to return the mobile terminal, the contact information includes at least one of: phone numbers, email addresses, work place addresses, and home addresses. In such embodiments, the information sending unit may send a prompt receipt notification to the notification designated location.

According to some embodiments of the disclosure, the notification designated location and/or the result designated location may include at least one of the following locations: servers, email addresses, web page space addresses, third party accounts, and mobile terminals of emergency contacts.

According to some embodiments of the disclosure, the privacy information may include at least one of the following information: contacts, call histories, SMS messages, MMS messages, photos, videos, SD card data, and account information.

In the present disclosure, the mobile terminal may automatically determine the theft status of the mobile terminal and hence automatically trigger mobile terminal anti-theft operations. The user does not need to master complicated anti-theft setting and operations, and may trigger the anti-theft operations as soon as he realize that his mobile terminal is lost, guaranteeing promising real-time performances and conveniences. The anti-theft operations of the present disclosure allow collecting clues (location information, environment information, etc.) in time, obtaining and backing up important personal data (private data) (and further deleting private data), so as to guarantee the security of data. Moreover, prompting to return information is enabled to help with finding the lost mobile terminal.

### BRIEF DESCRIPTION OF THE DRAWINGS

The above and other objects, features and advantages of the disclosure would become more apparent through the following preferred embodiments of the disclosure with reference to the drawings, in which:

FIG. 1 is a schematic diagram that shows an application scenario of a mobile communication system 1000 in accordance with the disclosure.

FIG. 2 is a flow chart that shows a mobile terminal intelligent anti-theft method 100 in accordance with an embodiment of the disclosure.

FIG. 3 is a block diagram that shows a mobile terminal 200 in accordance with an embodiment of the disclosure.

In all the drawings of the disclosure, like or similar reference numbers represent like or similar structures.

### DETAILED DESCRIPTION OF EMBODIMENTS

The preferred embodiments of the disclosure will be described in detail with reference to the drawings. However, details and functionalities that are not essential to the disclosure are omitted in the description to avoid introducing confusion when understanding the disclosure. Although the following contents are set forth in the context of wireless mobile communication, the disclosure is not limited thereto. The disclosure may apply to fixed communication systems, wired communication systems, or any mixed structures that combine wireless mobile communication systems, fixed communication systems or wired communication systems. As for mobile communication systems, the disclosure is not limited to specific communication protocols of various mobile communication terminals related in the description, which including but not limited to, 2G, 3G, 4G, 5G networks, WCDMA, CDMA2000, TD-SCDMA systems and the like. Different mobile terminals may adopt the same communication protocol or different communication protocols. The disclosure is not limited to a specific operating system in mobile terminals, which including but not limited to, iOS, Windows Mobile, Symbian, Android, Windows Phone, Blackberry OS and the like. Different mobile terminals may adopt the same operating system or different operating systems.

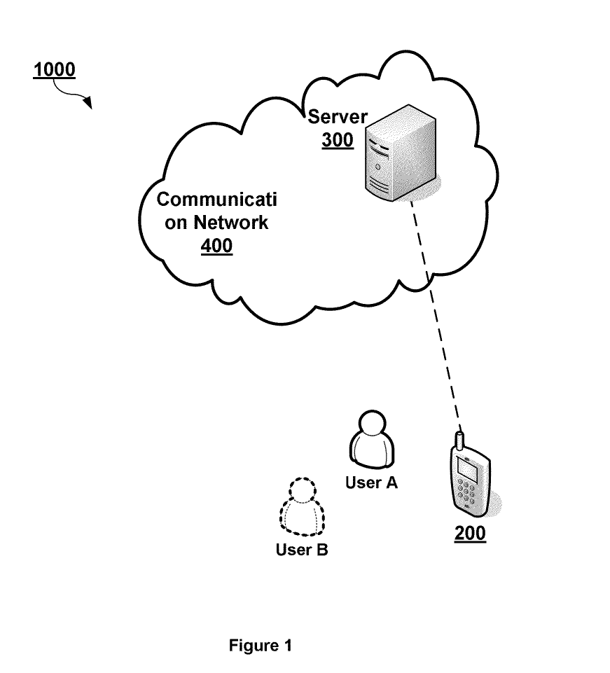

FIG. 1 is a schematic diagram that shows an application scenario of a mobile communication system 1000 in accordance with the disclosure. As shown in FIG. 1, the mobile communication system 1000 may include a mobile terminal 200 and a server 300. The mobile terminal 200 may be connected to the server 300 via a communication network 400. Examples of the communication network 400 include but not limited to: the Internet, mobile communication networks.

The mobile terminal 200 includes an intelligent anti-theft client (not shown) installed therein. The intelligent anti-theft client may be installed in the mobile terminal 200 by user A in the form of software, or by the manufacturer of the mobile terminal in the form of hardware or firmware.

The user A is a user or owner of the mobile terminal 200. The user A configures an anti-theft service on the mobile terminal 200. Particularly, the user A configures triggering conditions for anti-theft operations and activates the anti-theft service. For common users, all anti-theft operations may be activated with one action, for example, the anti-theft operations may include but not limited to, sending anti-theft operation initiation notification, locating the mobile terminal 200, obtaining environment information of the mobile terminal 200 (photos, videos, audios, etc.), sending location information and environment information, backing up important data, prompting to return information (e.g. displaying and/or voice broadcasting while the screen is locked), SIM card replacing notification (notifying information of the replacing SIM card), deleting important data, restoring factory settings (uninstalling all applications installed by user A) and the like. For advanced users, the anti-theft operations may be set by the user. For example, the user may select all or part of the above anti-theft operations. As another example, the user may select all or part of the data to be backed up or deleted, such as contacts, call histories, SMS messages, MMS messages, photos, videos, SD card data, and account information (for social applications, financial applications, etc.). In this case, priorities may be assigned to the data to be backed up or deleted (such as, contacts and photos are to be backed up or deleted with first priority). The triggering conditions for anti-theft operations may include but not limited to at least one of:
the number of failed unlocking attempts of the mobile terminal reaches a predetermined number;
the mobile terminal is forcedly turned off when in locked status;
a SIM card is replaced when the mobile terminal is in locked status;
an incorrect password is inputted when requesting restoring factory settings.

The following will be set forth with the first situation (i.e. the number of failed unlocking attempts of the mobile terminal reaches a predetermined number) as an example, but the disclosure is not limited thereto, as described above.

The user A enters the configuration page of the intelligent anti-theft client of the mobile terminal 200. First, the user A is prompted to set triggering conditions for anti-theft operations. At this time, the user A assigns a predetermined number (e.g., 1, 3 or 5) for failed unlocking attempts of the mobile terminal 200, and set a screen lock (which includes but not limited to passwords, patterns, etc.). Then, the user A is guided to set a notification designated location (e.g. the server 300, email addresses of the user A, web page space addresses of the user A, third party accounts (MSN, QQ, Gmail, Facebook, Twitter, etc.) of the user A, mobile terminals of emergency contacts of the user A, etc.) to which an anti-theft operation initiation notification (e.g. simple text notification such as “the anti-theft operations has been triggered”) is to be sent. And/or, the user A is guided to set a result designated location (e.g., the server 300, email addresses of the user A, web page space addresses of the user A, third party accounts (MSN, QQ, Gmail, Facebook, Twitter, etc.) of the user A, mobile terminals of emergency contacts of the user A, etc.) to which an anti-theft operation result (e.g. location information, environment information, important information, information of the replacing SIM card) is to be sent. The notification designated location may be the same as or different from the result designated location. Moreover, the notification designated location and the result designated location may be set as default (e.g., preset by the manufacturer of the mobile terminal 200 (as the Internet address of the manufacturer), and indicated in the specification of product). At this time, it might be not necessary to guide the user A to perform the above setting of the notification designated location and the result designated location. After the completion of the setting, the user A may be able to activate the anti-theft service with only one action (of course, more advanced setting is allowed).

After the user A has lost the mobile terminal 200, the user A do not need to perform any operation. Assume that another user B happens to pick up the mobile terminal 200 that the user A has lost, and attempts to unlock the screen lock of the mobile terminal 200. When the number of failed unlocking attempts of the mobile terminal 200 by the user B reaches the predetermined number, the anti-theft service of the intelligent anti-theft client of the mobile terminal 200 is triggered, and the mobile terminal 200 automatically performs a series of preset anti-theft operations. The user A may obtain the anti-theft operation initiation notification from the notification designated location (e.g., the server 300, email addresses of the user A, web page space addresses of the user A, third party accounts (MSN, QQ, Gmail, Facebook, Twitter, etc.) of the user A, mobile terminals of emergency contacts of the user A, etc.). At this time, the user A may view the anti-theft operation result that automatically delivered by the mobile terminal 200, at the result designated location (e.g., the server 300, email addresses of the user A, web page space addresses of the user A, third party accounts (MSN, QQ, Gmail, Facebook, Twitter, etc.) of the user A, mobile terminals of emergency contacts of the user A, etc.). Taking the case in which a QQ account and an email address are respectively set as the notification designated location and the result designated location as an example, when the anti-theft operations are triggered, the user A will receive in his QQ account a pop-up message window with text indication of “the anti-theft operations has been triggered”, and thus the user A may log into the email address to view the anti-theft operation result.

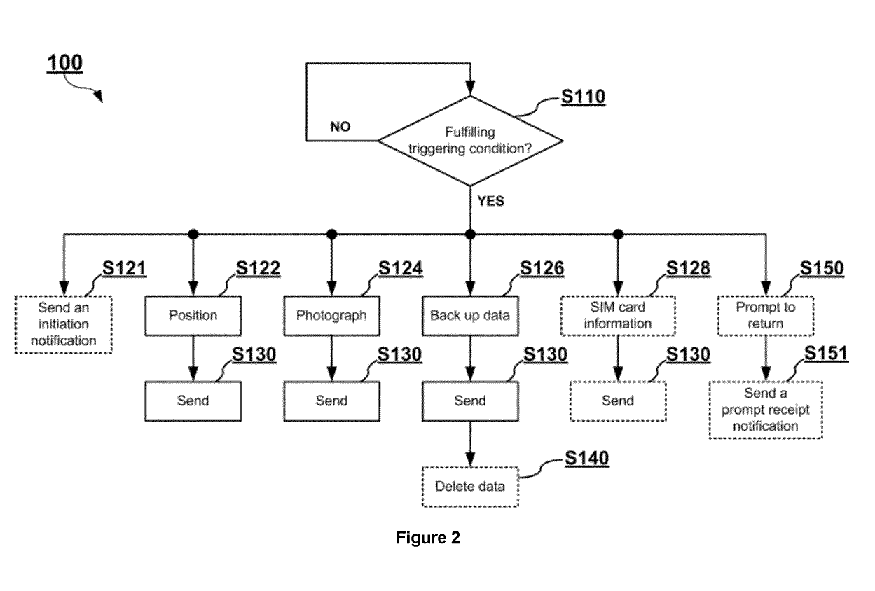

FIG. 2 is a flow chart that shows a mobile terminal intelligent anti-theft method 100 in accordance with an embodiment of the disclosure. As shown in FIG. 2, the mobile terminal locking method 100 may include the steps of S110, S121, S122, S124, S126, S128, S130, S140 and S150, wherein S110 is a step for triggering anti-theft operations, S121 is a step for notifying the initiation of the anti-theft operations, S122, S124, S126, S128 are steps for collecting information, S130 is a step for sending information, S140 is a step for deleting private data, and S150 and S151 are steps for prompting to return. In accordance with the disclosure, the notifying step S121, respective collecting information steps S122, S124, S126, S128 and the prompting to return step S150 may be performed individually or in any combination thereof, without limiting to the specific order illustrated in FIG. 2. For example, the mobile terminal intelligent anti-theft method 100 may be performed by the mobile terminal 200 shown in FIG. 1 or an intelligent anti-theft client installed in the mobile terminal 200.

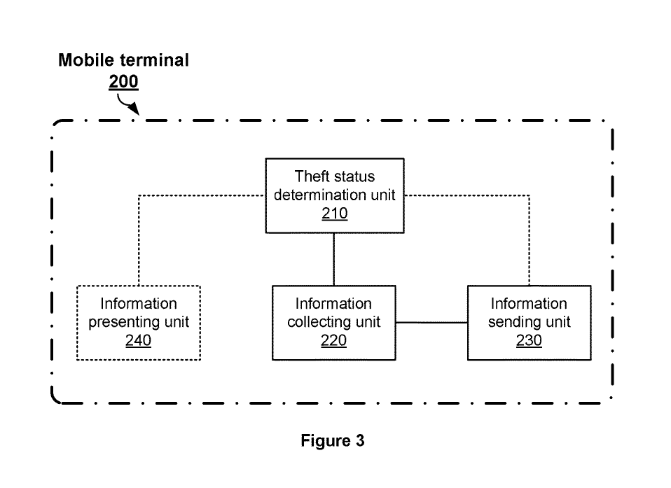

FIG. 3 is a block diagram that shows a mobile terminal 200 in accordance with an embodiment of the disclosure. As shown in FIG. 3, the mobile terminal 200 may include a theft status determination unit 210, an information collecting unit 220, an information sending unit 230 and an information presenting unit 240. The theft status determination unit 210 may trigger mobile terminal anti-theft operations according to operations on the mobile terminal 200. The information collecting unit 220 may collecting various data and information (such as location information, environment information (photos, videos, audios, etc.), contacts, call histories, SMS messages, MMS messages, photos, videos, SD card data, and account information (with respect to social network applications, financial applications, etc.), etc.) of the mobile terminal 200 according to instructions from the theft status determination unit 210. For example, the information collecting unit 220 may utilize existing hardware, firmware and/or software structures (such as GPS positioning component, camera, microphone, etc.) in the mobile terminal 200 to collect various information of the mobile terminal 200. The information sending unit 230 may send the anti-theft operation initiation notification and/or prompt receipt notification to the notification designated location (e.g., the server 300, email addresses of the user A, web page space addresses of the user A, third party accounts (MSN, QQ, Gmail, Facebook, Twitter, etc.) of the user A, mobile terminals of emergency contacts of the user A, etc.). The information sending unit 230 may also send data and information that collected by the information collecting unit 220 to the result designated location (e.g., the server 300, email addresses of the user A, web page space addresses of the user A, third party accounts (MSN, QQ, Gmail, Facebook, Twitter, etc.) of the user A, mobile terminals of emergency contacts of the user A, etc.). The information presenting unit 240 may display and/or voice broadcast contact information (such as phone numbers, email addresses, work place addresses, and home addresses, etc.) of the mobile terminal's owner to prompt to return the mobile terminal 200. For example, the information presenting unit 240 may utilize existing hardware, firmware and/or software structures (such as display and/or speaker, etc.) in the mobile terminal 200 to perform displaying and/or voice broadcasting.

The mobile terminal intelligent anti-theft method 100 and the mobile terminal 200 in accordance with the disclosure will be described in detail below in conjunction with FIGS. 2 and 3.

In step S110, the theft status determination unit 210 in the mobile terminal 200 monitors operations on the mobile terminal 200, and determines whether to trigger mobile terminal anti-theft operations according to the operations on the mobile terminal 200. For example, the mobile terminal anti-theft operations may be triggered when the operations on the mobile terminal 200 fulfill (step S110: YES) one of the following conditions (performing one or more of the steps of S121, S122, S124, S126, S128, S130, S140, S150, S151):
the number of failed unlocking attempts of the mobile terminal reaches a predetermined number (e.g. 1, 3, or 5);
the mobile terminal is forcedly turned off when in locked status;
a SIM card is replaced when the mobile terminal is in locked status;
an incorrect password is inputted when requesting restoring factory settings.

If it is determined not to trigger the mobile terminal anti-theft operations (step S110: NO), then returning to the step S110 and continue monitoring operations on the mobile terminal 200.

S122, S124 and S126 are information collecting steps. Not all these steps need to be performed, and it is possible that only some of the steps are performed according to requirement, system setting and/or user preferences. Additionally, these steps may be performed in a parallel manner, or according to a predetermined temporal sequence (based on system settings and/or user preferences).

In step S122, the information collecting unit 220 of the mobile terminal 200 positions the mobile terminal 200, collects location information of the mobile terminal 200, for example using existing GPS positioning components in the mobile terminal 200.

In step S124, the information collecting unit 220 of the mobile terminal 200 photographs and/or records (as videos or audios) ambient environment around the mobile terminal 200, and collects environment information (photos, videos, audios, etc.) of the mobile terminal 200, for example using existing camera and/or microphone in the mobile terminal 200.

In step S126, the information collecting unit 220 of the mobile terminal 200 backs up private data in the mobile terminal 200. The private information may include at least one of the following information: contacts, call histories, SMS messages, MMS messages, photos, videos, SD card data, social network application account information, financial application account information, etc.

In step 130, the information sending unit 230 of the mobile terminal 200 sends the collected location information and environment information of the mobile terminal 200 and the backup private data to the result designated location (e.g. the server 300, email addresses of the user A, web page space addresses of the user A, third party accounts (MSN, QQ, Gmail, Facebook, Twitter, etc.) of the user A, mobile terminals of emergency contacts of the user A, etc.).

In some embodiments of the disclosure, in step S121, the information sending unit 230 of the mobile terminal 200 sends the anti-theft operation initiation notification to the notification designated location (e.g. the server 300, email addresses of the user A, web page space addresses of the user A, third party accounts (MSN, QQ, Gmail, Facebook, Twitter, etc.) of the user A, mobile terminals of emergency contacts of the user A, etc.).

In some embodiments of the disclosure, in step S140, after the information sending unit 230 of the mobile terminal 200 has sent the backup private data to the result designated location, the information collecting unit 220 of the mobile terminal 200 deletes the private data in the mobile terminal. The private data deletion step S140 may be performed immediately or after a predetermined time period since the private data is backed up at the result designated position. However, the disclosure is not limited thereto.

In some embodiments of the disclosure, in step S128, the information collecting unit 220 of the mobile terminal 200 further detects whether the SIM card is replaced, and when the replacement is detected, information of the replacing SIM card is collected. In the case, in step S130, the information sending unit 230 of the mobile terminal 200 further sends the information of the replacing SIM card to the result designated location.

In some embodiments of the disclosure, in step S150, the information presenting unit 240 of the mobile terminal 200 displays and/or voice broadcasts contact information of the owner of the mobile terminal (e.g. phone numbers of the user A, email addresses of the user A, work place addresses of the user A, and home addresses of the user A), to prompt to return the mobile terminal 200, for example using existing display and/or speaker in the mobile terminal 200. When the holder (e.g. user B) of the mobile terminal 200 reads and/or hears the information, in step S151, the information sending unit 230 of the mobile terminal 200 may send a prompt receipt notification to the notification designated location. The step S151 may be performed at the same time as S150, or after or before S150.

The disclosure has been described in conjunction with preferred embodiments. It should be understood that those skilled in the art may perform any other modification, substitution and addition without departing from the spirit and scope of the present disclosure. Therefore, the scope of the disclosure is not limited to the above embodiments, and should be defined by the appended claims.

1. A mobile terminal intelligent anti-theft method (100), comprising:
triggering mobile terminal anti-theft operations according to operations on a mobile terminal (S110);
the mobile terminal anti-theft operations at least comprise:
collecting location information and environment information of the mobile terminal (S122, S124), and backing up private data in the mobile terminal (S126); and
sending the collected location information and environment information of the mobile terminal and the backup private data to a result designated location (S130).

2. The mobile terminal intelligent anti-theft method (100) according to claim 1, wherein the mobile terminal anti-theft operations are triggered when the operations on the mobile terminal fulfill one of the following conditions:
the number of failed unlocking attempts of the mobile terminal reaches a predetermined number;
the mobile terminal is forcedly turned off when in locked status;
a SIM card is replaced when the mobile terminal is in locked status;
an incorrect password is inputted when requesting restoring factory settings.

3. The mobile terminal intelligent anti-theft method (100) according to claim 1, wherein the mobile terminal anti-theft operations further comprise:
sending an anti-theft operation initiation notification to a notification designated location (S121).

4. The mobile terminal intelligent anti-theft method (100) according to claim 1, wherein the mobile terminal anti-theft operations further comprise:
deleting the private data in the mobile terminal after the backup private data is sent to the result designated location (S140).

5. The mobile terminal intelligent anti-theft method (100) according to claim 1, wherein the mobile terminal anti-theft operations further comprise:
when SIM card replacement is detected, collecting information of a replacing SIM card (S128); and
sending the information of the replacing SIM card to the result designated location (S130).

6. The mobile terminal intelligent anti-theft method (100) according to claim 1, wherein the mobile terminal anti-theft operations further comprise:
displaying and/or voice broadcasting contact information of the mobile terminal's owner to prompt to return the mobile terminal, the contact information comprises at least one of: phone numbers, email addresses, work place addresses, and home addresses (S150).

7. The mobile terminal intelligent anti-theft method (100) according to claim 6, wherein the mobile terminal anti-theft operations further comprise:
sending a prompt receipt notification to the notification designated location (S151).

8. The mobile terminal intelligent anti-theft method (100) according to claim 1, wherein the notification designated location and/or the result designated location includes at least one of the following locations: servers, email addresses, web page space addresses, third party accounts, and mobile terminals of emergency contacts.

9. The mobile terminal intelligent anti-theft method (100) according to claim 1, wherein the privacy information includes at least one of the following information: contacts, call histories, SMS messages, MMS messages, photos, videos, SD card data, and account information.

10. A mobile terminal (200), comprising:
a theft status determination unit (210), configured to trigger mobile terminal anti-theft operations according to operations on the mobile terminal;
an information collecting unit (220), configured to collect location information and environment information of the mobile terminal and back up private data in the mobile terminal, based on instructions from the theft status determination unit; and
an information sending unit (230), configured to send the location information and the environment information of the mobile terminal which is collected by the information collecting unit and the backup private data to a result designated location.

11. The mobile terminal (200) according to claim 10, wherein the theft status determination unit (210) may trigger the mobile terminal anti-theft operations when the operations on the mobile terminal fulfill one of the following conditions:
the number of failed unlocking attempts of the mobile terminal reaches a predetermined number;
the mobile terminal is forcedly turned off when in locked status;
a SIM card is replaced when the mobile terminal is in locked status;
an incorrect password is inputted when requesting restoring factory settings.

12. The mobile terminal (200) according to claim 10, wherein the information sending unit (230) is further configured to send an anti-theft operation initiation notification to a notification designated location.

13. The mobile terminal (200) according to claim 10, wherein the information collecting unit (220) deletes the private data in the mobile terminal after the backup private data is sent to the result designated location by the information sending unit (230).

14. The mobile terminal (200) according to claim 10, wherein the information collecting unit (220) is further configured to detect whether the SIM card is replaced, and collect information of a replacing SIM card when SIM card replacement is detected; and
the information sending unit (230) is further configured to send the information of the replacing SIM card to the result designated location.

15. The mobile terminal (200) according to claim 10, further comprising:
an information presenting unit (240), configured to display and/or voice broadcast contact information of the mobile terminal's owner to prompt to return the mobile terminal, the contact information comprises at least one of: phone numbers, email addresses, work place addresses, and home addresses.

16. The mobile terminal (200) according to claim 15, the information sending unit (230) may send a prompt receipt notification to the notification designated location.

17. The mobile terminal (200) according to claim 10, the notification designated location and/or the result designated location includes at least one of the following locations: servers, email addresses, web page space addresses, third party accounts, and mobile terminals of emergency contacts.

18. The mobile terminal (200) according to claim 10, the privacy information includes at least one of the following information: contacts, call histories, SMS messages, MMS messages, photos, videos, SD card data, and account information.
